(19) United States
(12) Patent Application Publication
(10) Pub. No.: US 2020/0334700 A1
(43) Pub. Date: Oct. 22, 2020

(54) SYSTEM AND METHOD FOR PROMOTION OPTIMIZATION USING MACHINE LEARNING

(71) Applicant: Tata Consultancy Services Limited, Mumbai (IN)

(72) Inventors: Jeisobers THIRUNAVUKKARASU, Chennai (IN); Shobitha MADHAVAN, Chennai (IN)

(73) Assignee: Tata Consultancy Services Limited, Mumbai (IN)

(21) Appl. No.: 16/818,407

(22) Filed: Mar. 13, 2020

(30) Foreign Application Priority Data
Apr. 19, 2019 (IN) 201921015718

(51) Int. Cl. G06Q 30/02; G06N 20/00

(52) U.S. Cl. CPC G06Q 30/0211; G06Q 30/0202; G06N 20/00; G06Q 30/0282; G06Q 30/0283

(57) ABSTRACT

This disclosure relates to a system and method to estimate optimal promotional value of a product while considering one or more promotional strategies of the organization. Retailers commonly employ promotions to improve sales volume, revenues, profits and customer satisfaction. Understanding of customer reactions to promotions at granular level will be critical for the success of promotion execution. The system and method to estimate effect of price discount percentage on individual promotion success criteria such as increasing basket size, boosting customer loyalty and raising profit. It is addressed by creating multivariate multi structure machine learning model and it is used to estimate probability to address a cannibalization, a complementarity effect, a stock up, a preferred segment of customer, and a required profit for a price discount. Finally, a promotional value is recommended for each product of a store by considering various promotion evaluation parameters.

### CROSS-REFERENCE TO RELATED APPLICATIONS AND PRIORITY

This U.S. patent application claims priority under 35 U.S.C. § 119 to India Application No. 201921015718, filed on Apr. 19, 2019. The entire contents of the abovementioned application are incorporated herein by reference.

### TECHNICAL FIELD

The disclosure herein generally relates to a field of promotion optimization of a product and, more particularly, a system and method for a promotion optimization of a product at a store level through a machine learning model.

### BACKGROUND

In retail scenario, retailers commonly employ promotions to improve sales volume, revenues, profits and customer satisfaction. Large teams of buyers, promo analyst, marketing members and category managers decide promotion strategies of items from experience and rules. Understanding at a granular level how customers react to promotions and understanding of the mechanism which makes the customer switch from one product to another will be critical for the success of promotion.

In real retail scenario the estimated optimal values of prices for selected products may not align with overall enterprise objectives. The reason is that promotion is evaluated at higher levels which creates challenges in addressing enterprise vision of promotion such as right promotion to right customers, absence of cannibalization effect and presence of a complementarity effect and a stock up during promotion, and positive pocket margin. In order to track movement of customers from one product to another product and measuring loyalty criteria, it requires in depth repeated processing of data which may requires huge memory power and timing.

In addition, to create a slider tool which could show the movement of promotion evaluation parameters in response to changes in price discount, it requires advanced analytical methods which could handle micro information and process to capture minor changes in the promotion evaluation parameters. Current technology considers consolidated information to evaluate promotion effectiveness. It is challenging to derive promotion effectiveness at ground level by using consolidated information.

Thus, the disclosure herein provides systems and methods to address the above points. By considering all these factors the disclosure suggests an approach of estimating the effect of price discount percentage on individual promotion evaluation parameters as per company's overall promotion objectives. It also suggests how it could be visualized in a user-friendly format.

### SUMMARY

Embodiments of the present disclosure provides data processing system and method as solutions to one or more of the above-mentioned promotion optimization problems recognized by the inventors in conventional systems. For example, in one embodiment, a method and system for estimating optimal promotional value to one or more products while considering company's overall promotion strategies such as increasing basket size, boosting customer loyalty and raising profit is provided.

A processor-implemented method to estimate optimal promotional value to each of one or more products at a store level while considering one or more promotional strategies of the organization. Wherein the one or more promotional strategies includes increasing basket size, boosting customer loyalty and raising profit. It would be appreciated that understanding about customer reaction to promotions at granular level and understanding of the mechanism which makes the customer switch from one product to another will be critical for the success of promotion strategies.

The method comprises one or more steps as collecting a set of drivers of sales of the one or more products of a predefined category from one or more source of information, wherein the one or more source of information includes a point of sale (POS), a historical promotion, a competitor information, a demography of store, and a customer master data. Further, the collected set of drivers of the one or more products are processed at a product transaction level and the information associated with the product. Furthermore, generating a data matrix of the processed information provide a multivariate multi-structure, wherein the data matrix comprises a plurality of rows and columns. The plurality of rows comprises the processed information at store product transaction level such as percentage of discount at the time of transaction, type of offer, type of customer who bought the product, stage of product life cycle, competitor price of the product at the time of transaction, etc. The plurality of columns comprises one or more variable indicators denoting success or failure based on cannibalization effect, a complementarity effect, a stock up effect, a preferred segment of customer, and a required profit under predefined parameters. Further, developing a multivariate multi-structure machine learning model for each of the one or more products based on the processed information from one or more sources. The multivariate multi-structure machine learning model is used to estimate a probability to address a cannibalization, a complementarity effect, a stock up effect, the preferred segment of customer, and a required profit for a predefined price discount. Finally, recommending a promotional value of each product using the estimated probability related with the one or more parameters and the recommendation is done at the store product level.

A system is configured to estimate optimal promotional value of a product while considering one or more promotional strategies of the organization. Wherein the one or more promotional strategies includes increasing basket size, boosting customer loyalty and raising profit. The system comprising at least one memory storing a plurality of instructions and one or more hardware processors communicatively coupled with the at least one memory. The one or more hardware processors are configured to execute one or more modules comprises of a data collection module, a data processing module, a data matrix generation module, a buying pattern detection module, a model development module, a probability estimator module, and a recommendation module.

The data collection module is configured to collect a set of drivers of sales of a plurality of products of a predefined category from one or more source of information, wherein the one or more source of information includes a point of sale (POS), a historical promotion, a competitor information, a customer master data and a demography of store. The data processing module is configured to process the collected information at product level and the information associated with the product. The data matrix generation module is configured to generate a data matrix of the processed information to provide a multivariate multi-structure, wherein the data matrix comprises a plurality of columns and rows. The buying pattern detection module is configured to determine an indicative value of success or failure based on the multivariate distance from those baskets having the product concerned. The model development module is configured to develop a multivariate multi-structure machine learning model for each of the one or more products based on the processed information from one or more sources. The probability estimator module is configured to estimate a probability to address a cannibalization, a complementarity effect, a stock up effect, a preferred segment of customer, and a required profit for a predefined price discount. Finally, the recommendation module is configured to recommend a promotional value of each product using the estimated probability related with the one or more parameters and recommendation is done at individual product store level.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates a system to estimate optimal promotional value of a product while considering one or more promotional strategies of the organization, in accordance with some embodiments of the present disclosure;

FIG. 2 is a graphical representation for the different value of discount percentage and the success criteria movement against each causative factor, in accordance with some embodiments of the present disclosure; and

FIG. 3 is a flow diagram to illustrate a method to estimate optimal promotional value of a product while considering one or more promotional strategies of the organization, in accordance with some embodiments of the present disclosure.

It should be appreciated by those skilled in the art that any block diagrams herein represent conceptual views of illustrative systems and devices embodying the principles of the present subject matter. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION OF EMBODIMENTS

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The embodiments herein provide a method and a system to estimate optimal promotional value to one or more products at a store level while considering one or more promotional strategies of the organization. Wherein the one or more promotional strategies includes increasing basket size, boosting customer loyalty and raising profit. It would be appreciated that the optimal promotional value estimation herein involves analysis of the customer behavior towards promotion at micro level and relationship between a price discount and the customer change in buying pattern under different conditions such as competitor price of product under promotion, nature of product such as key value item, products under regular price within category, stage of life cycle of product under promotion and effect of location of the store.

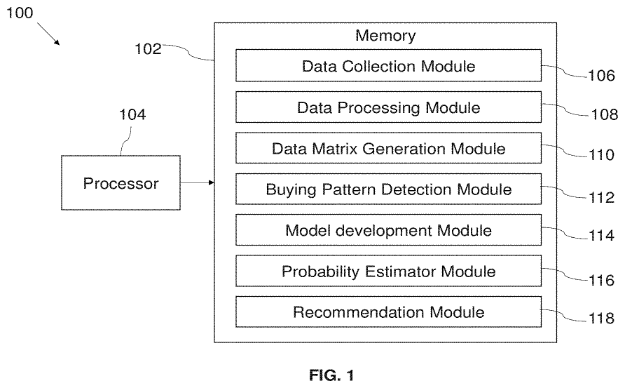

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 illustrates a system (100) to suggest optimal promotional value to one or more products while considering one or more promotional strategies of the organization. Wherein the one or more promotional strategies includes increasing basket size, boosting customer loyalty and raising profit. In the preferred embodiment, the system (100) comprises at least one memory (102) with a plurality of instructions and one or more hardware processors (104) which are communicatively coupled with the at least one memory (102) to execute modules therein.

The hardware processor (104) may be implemented as one or more microprocessors, microcomputers, microcontrollers, digital signal processors, central processing units, state machines, logic circuitries, and/or any devices that manipulate signals based on operational instructions. Among other capabilities, the hardware processor (104) is configured to fetch and execute computer-readable instructions stored in the memory (102). Further, the system comprises a data collection module (106), a data processing module (108), a data matrix generation module (110), a buying pattern detection module (112), a model development module (114), a probability estimator module (116), and a recommendation module (118).

In the preferred embodiment of the disclosure, the data collection module (106) of the system (100) collects a set of drivers of sales together at different format and levels. It would be appreciated that the one or more sources includes POS (Point of Sale) information, competition information, historical promotions, and store demographics. It is to be noted that the one or more sources are not limited to above list. It may also comprise market share, customer lifestyle, customer behavior, and weather and seasonality. Some of the sources such as performance information are from the retailer and some of them such as competitor price are from third party vendors. All the sources will have different format and different level of information.

In the preferred embodiment of the disclosure, the data processing module (108) of the system (100) is configured to process the collected set of drivers of sales in a meaningful way at product transaction level and the information associated with the product. The information associated with the product includes a customer type identification, a product type identification, a stage of product life cycle, a number of similar SKUs under promotion, a number of similar SKUs under regular price, a profit per unit calculation, a highest comp price distance associated with each of the plurality of products. It would be appreciated that the set of drivers of sales include a demographic data associated with the plurality of products, and a recorded information of one or more competitors of the plurality of products.

In the preferred embodiment of the disclosure, the data matrix generation module (110) of the system (100) is configured to generate a data matrix of the processed information to provide a multivariate multi-structure. The data matrix comprises a plurality of columns and rows, wherein the plurality of rows comprises the processed information at store product transaction level and the plurality of columns comprises one or more variable indicators denoting success or failure based on cannibalization effect, a complementarity effect, a stock up effect, a preferred segment of customer, and a required profit under predefined parameters. Further, the data matrix is classified as an independent matrix and a dependent matrix.

The dependent matrix structure captures a cannibalization effect, a complementarity effect, a stock up effect, a customer criterion, and a profit criteria and the independent matrix has all causative factors related with the one or more products under promotion. The causative factors include a price discount, a type of product, a comp price distance, a product lifecycle stage, a type of offer, a trip type, a number of similar SKUs under promotion, a number of similar SKUs under regular price, a day effect and demographics of the store.

In the preferred embodiment of the disclosure, the buying pattern detection module (112) of the system (100) is configured to determine an indicative value of success or failure based on a predefined cannibalization criterion within a category. Customer historical baskets are coded in matrix format where each column represent product and rows represent baskets and cells represent presence or absence of the product for the basket. If there are m products, then m columns are created. The matrix is used to extract product purchase pattern in the form of frequency distribution of products within a category by considering all the baskets of historical purchases and it could be termed as standard pattern for a customer for a category. It should be appreciated that the usual buying pattern of each of the one or more customers is reflected in standard pattern in the form of product spread within a category and top product of standard pattern are identified. The distance between each basket pattern and standard pattern is calculated using multivariate distance such as Euclidean or Mahalanobis, etc.

In one example, wherein if a customer has n baskets then n multivariate distances is calculated. The variation across these n multivariate distances is used to identify outlier which reflects customer changing pattern of purchase with respect to product spread. Outlier identification technique such as IQR (Inter quartile range) method or Z score is applied on the n multivariate distances of the trips. If the trip has the product for which promotional value is going to be recommended comes under outlier, then it could be cannibalization or complementarity. If the trip comes as outlier and if the top product of the standard pattern is present in the trip, then the trip is termed as complementarity and it is noted as 1 against complementarity column of dependent matrix else it is noted as 0. Similarly, wherein the trip comes as outlier and the top product of the standard pattern is absent in the trip, then the trip has cannibalization and it is noted as 1 against cannibalization column of dependent matrix else it is noted as 0.

In the preferred embodiment, the following procedure is followed to indicate success or failure based on the stock up. The customer historical baskets are coded in matrix format where each column represent product and rows represent baskets and cells represent number of units bought for the product. If there are m products, then m columns are created. The matrix is used to extract product purchase pattern in the form of average buying units for each product for a basket within a category by considering all the baskets of historical purchases and it could be termed as standard pattern for a customer for a category. Customer usual buying pattern is reflected in standard pattern. The distance between each basket pattern and standard pattern is calculated using multivariate distance such as Euclidean or Mahalanobis, etc. So, each trip done by customer will have a multivariate distance. If a customer has n baskets, then n multivariate distances is calculated. The variation across these n multivariate distances is used to identify outlier which reflects customer changing pattern of purchase in terms of number of units. Outlier identification technique such as IQR (Inter quartile range) method or Z score is applied on the n multivariate distances of the trips. If the trip has the product for which promotional value is going to be recommended comes under outlier then it is due to stock up and it is noted as 1 against stock up column of dependent matrix else it is noted as 0.

In one example, wherein one or more loyal customers are identified based on one or more loyal parameters such as frequency and monetary. Top 20% customers are identified as loyal customers based on distribution and each transaction is noted as 1 if the customer who is buying the product for which promotional value is going to be recommended is loyal else it is noted as 0 in the dependent matrix. Profit is calculated by considering vendor contribution and if it comes positive then the transaction is noted as 1 else 0 against the column in dependent matrix. Pocket margin refers to the amount left in a company's pocket after all of the costs related to a transaction, as well as the cost of goods sold, are subtracted from the list price. If pocket margin happens for a transaction is positive it is noted as 1 else 0 against the column in the dependent matrix.

Furthermore, it may be noted that the retailers used to have list of key value items for each category based on business rules. Wherein, the business rules may vary based on the predefined category of each product. For example, high velocity products would be considered as key value products. It is identified as top 20% of items based on sales $ or based on sales units maintained for last 3 to 5 years. Similarly, major products which have more affinity products would be considered as key value items. If the product is not coming under any category, then it is noted as others which indicates that they are not key value items. So, each transaction of the product for which promotional value is going to be recommended is noted as 1 against key value item column under independent matrix else it is noted as 0.

Further herein, the retailers used to have stage of life cycle for each product based on the product historical launching date and its current popularity among customers and it is stored in the product master data. For inclusion of product life cycle in the matrix, 5 columns are created separately in the independent matrix and each column is noted as 1 or 0 based on presence or absence of respective stage of product life cycle. Top few competitors price of the one or more products is received through a crawling of competitor websites. The difference between the retailer price and the competitor price is calculated as a price distance and it is repeated for major competitors. The competitor with maximum price distance will have the lowest price for the product and it is filtered and passed into independent matrix.

The one or more products under promotion within the predefined category at the time of transaction is calculated and put under the heading namely number of similar products under promotion in the independent matrix. It is to be noted that the day effect will take the value from 1 to 31 depending on time of transaction happened and it is noted under the column namely day effect in the independent matrix. Further, the store level demographics are mapped with transaction data based on store ID and it comes under independent matrix. It helps to learn the behavior of promotion response across different locations.

In the preferred embodiment of the disclosure, the model development module (114) of the system (100) is configured to develop a multivariate multi-structure machine learning model for each of the one or more products based on the processed information from one or more sources. The multivariate multi-structure machine learning models are developed using random forest technique which is an ensemble learning method for regression. There is provision in some of the open source software to consider multi-columns as dependent variable and independent matrix as causative factors. In one example, an open source software is R software which has package called Random Forest SRC. This package has provision to consider multivariate matrix as dependent variable and independent matrix as causative factors.

The dependent matrix structure captures one or more promotion evaluation parameters simultaneously and independent matrix has all causative factors available with the retailer. Both the independent and dependent matrix is passed into the machine learning models and the machine learning models relate independent matrix with dependent matrix. In other words, simultaneous consideration of all causative factors is mapped with simultaneous consideration of all promotion evaluation parameters through machine learning models. This set up learns the promotion behavior that exist in the passing information. In one example, the set up learns how each of the one or more promotion evaluation parameters varies when discount percentage varies while considering all other causative factors. The success of learning depends on the period of data used for learning and ideally it needs to be as long as possible and it should capture all possible scenarios that exist in real retail scenarios. The model with learnt behavior is ready to be used to estimate the probability for different conditions.

In the preferred embodiment of the disclosure, the probability estimator module (116) of the system (100) is configured to estimate probability to address a cannibalization, a complementarity effect, a stock up effect, a preferred segment of customer, and a required profit for a predefined price discount. It is to be noted that the one or more predefined promotional parameters comprise a percentage of discount, a mode of discount, a type of product, a stage of product life cycle, an expected competitor price, a promotional information of other products with the predefined category.

In the preferred embodiment of the disclosure, the recommendation module (118) of the system (100) is configured to recommend a promotional value of each product using the estimated probability related with the one or more parameters and recommendation is done at individual product store level. It should be appreciated that the discount percentage is varied from 0 to 100 and corresponding probability is estimated for each parameter using the trained multivariate multi-structure machine learning model. As there are six parameters such as the cannibalization, the complementarity, the stock up, a preferred segment of customer, a required pocket margin and the gross profit post vendor contribution are considered, six probabilities are estimated.

The probability of cannibalization is used to derive probability for no cannibalization by doing (1—probability of cannibalization). It is done to ensure all the parameters have desired effect in one direction as per business context. The estimated probabilities of 5 parameters and probability for no cannibalization are compared simultaneously with ideal probability of 1 for each parameter and multivariate distance is estimated. The discount percentage at which the multivariate distance is minimum then that point is noted as recommended promotional value. The estimated probability for each criterion is the input for the slider tool which shows the movement of promotion evaluation parameters in response to changes in price discount.

In one example, wherein if business user wants to give more weight to certain parameters say profit as compared to other parameters the weights are added with probability for profit while estimating the multivariate distance. The weights are derived in such a way that addition of all weights to be added up to 1.

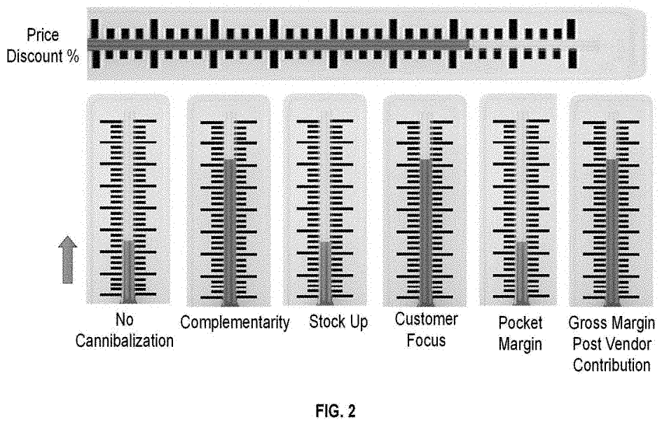

Referring FIG. 2, a graphical representation, wherein a slider tool to show the movement of promotion evaluation parameters in response to changes in price discount. The slider tool has 6 columns and a top slider. Each column shows the probability of respective promotion evaluation parameter for a given price discount which is shown by top slider. The six promotion evaluation parameters considered are cannibalization effect, a complementarity effect, a stock up effect, reaching the preferred segment of customer, pocket margin and a profit post vendor contribution for a predefined price discount.

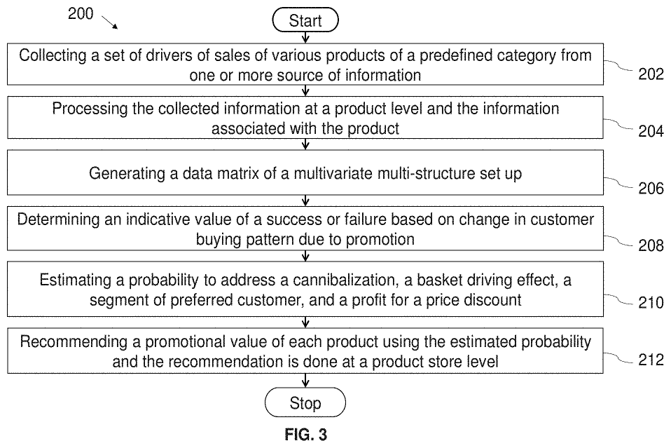

Referring FIG. 3, a processor-implemented method (200) to estimate optimal promotional value to one or more products at a store level while considering one or more promotional strategies of the organization. Wherein the one or more promotional strategies includes increasing basket size, boosting customer loyalty and raising profit. The method comprises one or more steps as follows.

Initially, at the step (202), a set of drivers of sales of one or more products of a predefined category are collected at a data collection module (106) of the system (100) from one or more sources. The one or more sources include a point of sale (POS), a historical promotion, a competitor information, a demography of store, and a customer master data.

In the preferred embodiment of the disclosure, at the next step (204), processing at a data processing module (108) of the system (100) the collected set of drivers of sales at a product level and the information associated with the product. It would be appreciated that the information associated with each product includes a customer type identification, a product type identification, a stage of product life cycle, a number of similar SKUs under promotion, a number of similar SKUs under regular price, a profit per unit calculation, a highest comp price distance associated with each of the one or more products.

In the preferred embodiment of the disclosure, at the next step (206), generating a data matrix of the processed information at a data matrix generation module (110) of the system (100) to provide a multivariate multi-structure. The data matrix comprises a plurality of columns and rows related with a particular product for which promotional value is going to be recommended and which has historical promotion information in the past. Further, the data matrix is classified as an independent matrix and a dependent matrix. The dependent matrix structure captures a cannibalization effect, a complementarity effect, a stock up effect, a customer criterion, and a profit criterion. The independent matrix has all causative factors related with the one or more products under promotion. The causative factors include a price discount, a type of product, a comp price distance, a product lifecycle stage, a type of offer, a trip type, a number of similar SKUs under promotion, a number of similar SKUs under regular price, a day effect and demographics of each product at the store.

In the preferred embodiment of the disclosure, at the next step (208), determining an indicative value of a success or failure for the cannibalization, complementarity and stock up by comparing with standard buying pattern at a buying pattern detection module (112) of the system (100). Herein, the indicative value is an indicator of the presence and absence of cannibalization for a given price discount within a predefined category.

In the preferred embodiment of the disclosure, at the next step (210), develop a multivariate multi-structure machine learning model for each of the one or more products based on the processed information from one or more sources at a model development module (114) of the system (100). The dependent matrix structure captures promotion evaluation parameters simultaneously and independent matrix has all causative factors available with retailer. Both independent and dependent matrix is passed into machine learning models and the machine learning models will relate independent matrix with dependent matrix.

In other words, simultaneous consideration of all causative factors is mapped with simultaneous consideration of all promotion evaluation parameters through machine learning models. This set up will try to learn the promotion behavior that exist in the passing information. This set up learns how promotion evaluation parameters varies when discount percentage varies while considering all other causative factors. The success of learning depends on the period of data used for learning and ideally it needs to be as long as possible and it should capture all possible scenarios that exist in real retail scenarios. The model with learnt behavior is ready to be used to estimate the probability for different conditions.

In the preferred embodiment of the disclosure, at the step (212), estimating a probability to address a cannibalization, a complementarity effect, a stock up effect, a preferred segment of customer, and a required profit for a predefined price discount at a probability estimator module (116) of the system (100). The probability estimation is done related with the one or more predefined parameters, the one or more predefined parameters comprise a percentage of discount, a mode of discount, a type of product, a stage of product life cycle, an expected competitor price and a promotional information of one or more related products.

In the preferred embodiment of the disclosure, at the last step (214), recommending a promotional value of each product using the estimated probability related with the one or more parameters and recommendation is done at individual product store level at a recommendation module (118) of the system (100). It would be appreciated that the discount percentage is varied from 0 to 100 and corresponding probability is estimated for each parameter using the trained multivariate multi-structure machine learning model. As there are six parameters such as the cannibalization, the complementarity, the stock up, a preferred segment of customer, a required pocket margin and the gross profit post vendor contribution are considered, six probabilities are estimated. The probability of cannibalization is used to derive ‘probability for no cannibalization’ by doing (1—probability of cannibalization). It is done to ensure all the parameters have desired effect in one direction as per business context. The estimated probabilities of 5 parameters and probability for no cannibalization are compared simultaneously with ideal probability of 1 for each parameter and multivariate distance is estimated. The discount percentage at which the multivariate distance is minimum then that point is noted as recommended promotional value.

It would be appreciated that if business user wants to give more weight to certain parameters say for example profit as compared to other parameters the weights are added with probability while estimating the multivariate distance. The weights are derived in such a way that addition of all weights is added up to 1.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein address unresolved problem of effect of price discount percentage on individual promotion evaluation parameters as per enterprise vision. The reason is that in real retail scenario the estimated optimal values of prices for selected products may not align with overall enterprise objectives. The promotion is evaluated at higher levels which creates challenges in addressing company's overall promotion strategies such as increasing basket size, boosting customer loyalty and raising profit. Current technology considers consolidated information to evaluate promotion effectiveness. It is challenging to derive promotion effectiveness at ground level by using consolidated information.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A system comprising:
at least one memory storing a plurality of instructions;
one or more hardware processors communicatively coupled with the at least one memory, wherein the one or more hardware processors are configured to execute one or more modules;
a data collection module configured to collect a set of drivers of sales of each of one or more products of a predefined category from one or more source of information, wherein the one or more source of information includes a point of sale (POS), a historical promotion, a competitor information, a customer master data and a demography of store;
a data processing module configured to process the collected information at product level and the information associated with the product;
a data matrix generation module configured to generate a data matrix of the processed information to provide a multivariate multi-structure, wherein the plurality of rows comprises the processed information at store product transaction level and the plurality of columns comprises one or more variable indicators denoting success or failure on predefined parameters;
a buying pattern detection module configured to determine an indicative value of success or failure for the cannibalization, complementarity and stock up by comparing with standard buying pattern;
a model development module configured to develop a multivariate multi-structure machine learning model for each of the one or more products based on the processed information from one or more sources of information;
a probability estimator module configured to estimate a probability to address a cannibalization, a complementarity effect, a stock up effect, a preferred segment of customer, and a required profit for a predefined price discount; and
a recommendation module configured to recommend a promotional value of each product using the estimated probability related with the one or more parameters and recommendation is done at individual product store level.

2. The system claimed in claim 1, wherein the information associated with product includes an information of a customer, a customer type identification, a product type identification, a stage of product life cycle, a number of similar SKUs under promotion, a number of similar SKUs under regular price, a profit per unit calculation, a highest comp price distance associated with each of the one or more products.

3. The system claimed in claim 1, wherein the indicative value is an indicator of the presence and absence of cannibalization for a given price discount within a predefined category.

4. The system claimed in claim 3, wherein the cannibalization is a repeated multilevel processing to provide an indicative value of a success or failure based on the multivariate distance from the at least one basket having the product.

5. The system claimed in claim 1, wherein the one or more predefined promotional parameters comprise a percentage of discount, a mode of discount, a type of product, a stage of product life cycle, an expected competitor price, a promotional information of other products with the predefined category.

6. The system claimed in claim 1, wherein the plurality of rows of the data matrix comprise the processed information at the store product transaction level.

7. The system claimed in claim 1, wherein the plurality of columns comprise one or more variable indicators denoting success or failure based on a cannibalization effect, a complementarity effect, a stock up effect, a preferred segment of customer, and a required profit under predefined parameters.

8. The system claimed in claim 1, wherein the probability estimation is done based on one or more predefined parameters, wherein the one or more predefined parameters comprise a percentage of discount, a mode of discount, a type of product, a stage of product life cycle, an expected competitor price and a promotional information of one or more related products.

9. A processor-implemented method comprising:
collecting a set of drivers of sales of each of one or more products of a predefined category from one or more source of information, wherein the one or more source of information includes a point of sale (POS), a historical promotion, a competitor information, a customer master data and a demography of store;
processing the collected information at a product level and the information associated with the product;
generating a data matrix of the processed information to provide a multivariate multi-structure, wherein the data matrix comprises a plurality of columns and rows, wherein the plurality of rows comprises the processed information at store product transaction level and the plurality of columns comprises one or more variable indicators denoting success or failure on predefined parameters;
determining an indicative value of a success or failure for the cannibalization, complementarity and stock up by comparing with standard buying pattern;
developing a multivariate multi-structure machine learning model for each of the one or more products based on the processed information from one or more sources;
estimating a probability to address a cannibalization, a complementarity effect, a stock up effect, a preferred segment of customer, and a required profit for a predefined price discount; and
recommending a promotional value of each product using the estimated probability related with the one or more parameters and recommendation is done at individual product store level.

10. The method claimed in claim 9, wherein the information associated with product includes an information of a customer, a customer type identification, a product type identification, a stage of product life cycle, a number of similar SKUs under promotion, a number of similar SKUs under regular price, a profit per unit calculation, a highest comp price distance associated with each of the plurality of products.

11. The method claimed in claim 9, wherein the indicative value is an indicator of the presence and absence of cannibalization for a given price discount within a predefined category.

12. The method claimed in claim 11, wherein the cannibalization is a repeated multilevel processing to provide an indicative value of a success or failure based on the multivariate distance from the basket having the product.

13. The method claimed in claim 9, wherein the one or more predefined promotional parameters comprise a percentage of discount, a type of product, a stage of product life cycle, an expected competitor price, a mode of discount, a promotional information of other products with the predefined category.

14. The method claimed in claim 9, wherein the data matrix comprises a cannibalization effect, a complementarity effect, a stock up effect, a customer criteria, and a profit criteria as dependent matrix and a price discount, a type of product, a comp price distance, a product lifecycle stage, a type of offer, a number of similar SKUs under promotion, a number of similar SKUs under regular price, a day effect and demographics as independent matrix.

15. The method claimed in claim 9, wherein the probability estimation is done related with the one or more predefined parameters, the one or more predefined parameters comprise a percentage of discount, a mode of discount, a type of product, a stage of product life cycle, an expected competitor price and a promotional information of one or more related products.
